(19) United States
(12) Patent Application Publication
(10) Pub. No.: US 2024/0350920 A1
(43) Pub. Date: Oct. 24, 2024

(54) STORAGE MEDIUM, GAME SYSTEM, GAME APPARATUS, AND GAME PROCESSING METHOD

(71) Applicant: Nintendo Co., Ltd., Kyoto (JP)

(72) Inventors: Naoki FUKADA, Kyoto (JP); Atsushi ASAKURA, Kyoto (JP); Akira FURUKAWA, Kyoto (JP); Kazuhiro KAWAMURA, Kyoto (JP)

(21) Appl. No.: 18/507,647

(22) Filed: Nov. 13, 2023

(30) Foreign Application Priority Data
Apr. 20, 2023 (JP) 2023-069352

(51) Int. Cl. A63F 13/577; A63F 13/44

(52) U.S. Cl. CPC A63F 13/577; A63F 13/44

(57) ABSTRACT

Movement control is executed on at least one movable, dynamic object in a virtual space based on physical calculation. At least one explosion is generated with timing based on a game process. When the at least one explosion occurs, a location and orientation of a target object present within a range from an occurrence position where each explosion occurs are calculated based on physical calculation, assuming that a position on the target object closest to the occurrence position is an impact position, and if the target object is the dynamic object, a point having a first mass hits the target object at the impact position at a first speed in a direction from the occurrence position toward the impact position.

### CROSS REFERENCE TO RELATED APPLICATIONS

This application claims priority to Japanese Patent Application No. 2023-069352, filed on Apr. 20, 2023, the entire contents of which are incorporated herein by reference.

### FIELD

The technology disclosed herein relates to a storage medium, game system, game apparatus, and game processing method that executes a process using an object in a virtual space.

### BACKGROUND AND SUMMARY

There has conventionally been a game program in which an object in a virtual space is used. For example, in such a game program, a player character carries out an explosion in a virtual space so as to destroy or blow away an object that is located in a range under an influence of the explosion.

However, in the above game program, it has not been easy for the user to adjust the location of the explosion such that the object is accurately moved in an expected or intended direction.

With the above in mind, it is an object of the present example to provide a storage medium, game system, game apparatus, and game processing method that allow the user to easily move an object in an intuitively expected or intended direction from a location where an explosion occurs in a virtual space.

To achieve the object, the present example may have features (1) to (7) below, for example.

(1) A non-transitory computer-readable storage medium according to the present example has stored therein instructions that, when executed, cause one or more processors of an information processing apparatus to execute game processing comprising: executing movement control on at least one movable, dynamic object in a virtual space based on physical calculation; generating at least one explosion with timing based on a game process; and when the at least one explosion occurs, calculating a location and orientation of a target object present within a range from an occurrence position where each explosion occurs, based on physical calculation, assuming that a position on the target object closest to the occurrence position is an impact position, and if the target object is the dynamic object, a point having a first mass hits the target object at the impact position at a first speed in a direction from the occurrence position toward the impact position.

With the configuration of (1), when the dynamic object is moved based on the occurrence of the explosion, the dynamic object can be moved in a direction close to that which is intuitively expected from the occurrence position where the explosion occurs.

(2) In the configuration of (1), the dynamic object may include a bomb object, and the game processing may further comprise: joining at least one of the bomb objects to at least one of the dynamic objects in the virtual space based on an operation input to obtain an assembly object, which is a dynamic object, and executing movement control on the assembly object based on the physical calculation; and generating the explosion at a location of the bomb object with timing specified based on an operation input.

With the configuration of (2), the bomb object can be caused to explode with the bomb object fixed to the dynamic object, and therefore, can be previously arranged such that the dynamic object should be moved in a desired direction.

(3) In the configuration of (2), the bomb object may explode after a period of time has passed since performance of an operation input of commanding to explode.

With the configuration of (3), preparation for movement due to an explosion can be performed during a period of time from the time of commanding to explode to the time of the explosion.

(4) In the configuration of (2) or (3), the game processing may further comprise: controlling a player character in the virtual space based on an operation input. The operation input of commanding to explode may be to cause the player character to perform an action on the bomb object or the assembly object including the bomb object, based on an operation input.

With the configuration of (4), a command to explode can be given by a predetermined action on the assembly object. Therefore, one or more bomb objects can be simultaneously activated, which can facilitate the control of the direction in which the assembly object is moved. In addition, in the case of a bomb object that explodes after a predetermined period of time has passed since the command to explode, the player character can move until the explosion occurs.

(5) In the configuration of any one of (1) to (4), the game processing may further comprise: when the explosion occurs, temporarily increasing the moment of inertia tensor of the target object before executing the physical calculation.

With the configuration of (5), for a moment of an explosion, a change in the direction due to factors other than the explosion can be inhibited, and therefore, the dynamic object can be inhibited from moving in a direction different from that which is intuitively expected from the explosion occurrence position.

(6) In the configuration of any one of (1) to (5), the target object may be all objects that are at least partially included within a distance from the explosion occurrence position.

With the configuration of (6), a dynamic object that is to be moved by an explosion can be chosen from dynamic objects in the virtual space, and a plurality of dynamic objects can be moved by an explosion.

(7) In the configuration of any one of (1) to (6), at least one of the first mass and the first speed may be set to a value that decreases with an increase in a distance between the occurrence position and the impact position.

With the configuration of (7), a more realistic explosion can be expressed.

In addition, the present example may be carried out in the forms of a game system, game apparatus, and game processing method.

According to the present example, when a dynamic object is moved due to the occurrence of an explosion, the dynamic object can be moved in a direction close to that which is intuitively expected from an occurrence position where the explosion occurs.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a diagram illustrating a non-limiting example of a game image showing that a player character PC activates a bomb item B in a virtual space,

FIG. 9 is a diagram illustrating a non-limiting example of a game image showing that a bomb item B activated by a player character PC explodes,

FIG. 10 is a diagram illustrating a non-limiting example of a game image showing that a player character PC causes an object to be controlled to move, by an object operation action,

FIG. 11 is a diagram illustrating a non-limiting example of a game image showing that a player character PC attaches an object to be controlled to an object OBJa,

FIG. 12 is a diagram illustrating a non-limiting example of a game image showing that a player character PC attaches an object to be controlled to an object OBJa to generate an assembly object AS,

FIG. 13 is a diagram illustrating a non-limiting example of a game image showing that a player character PC activates bomb items B included in an assembly object AS in a virtual space,

FIG. 14 is a diagram illustrating a non-limiting example of a game image showing an assembly object AS when bomb items B activated by a player character PC explode,

FIG. 15 is a diagram illustrating a non-limiting example of explosion thrusts applied to an object R,

FIG. 16 is a diagram illustrating a non-limiting example of a data area set in a DRAM 85 of a main body apparatus 2,

FIG. 17 is a flowchart illustrating a non-limiting example of a game process that is executed in a game system 1,

FIG. 18 is a subroutine illustrating a non-limiting example of a bomb item-related process in step S123 of FIG. 17,

FIG. 19 is a subroutine illustrating a non-limiting example of an explosion thrust generation process in step S139 of FIG. 18 and step S152 of FIG. 20,

FIG. 20 is a subroutine illustrating a non-limiting example of an other-explosion process in step S124 of FIG. 17, and

FIG. 21 is a subroutine illustrating a non-limiting example of a dynamic object updating process in step S125 of FIG. 17.

### DETAILED DESCRIPTION OF NON-LIMITING EXAMPLE EMBODIMENTS

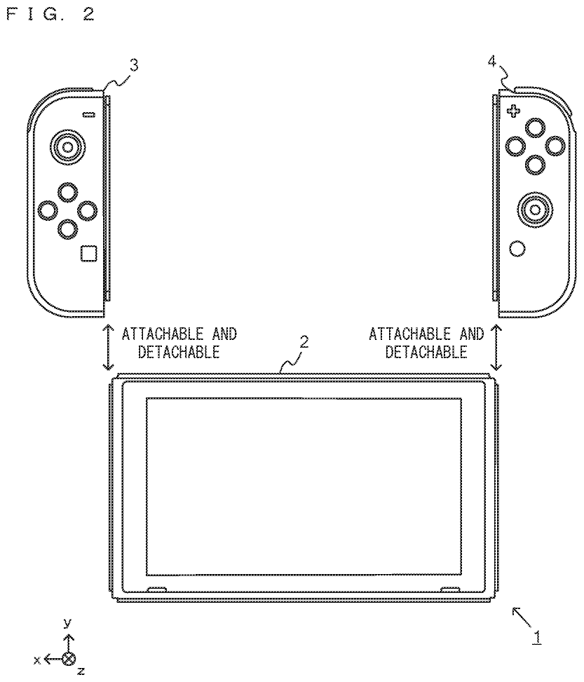

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

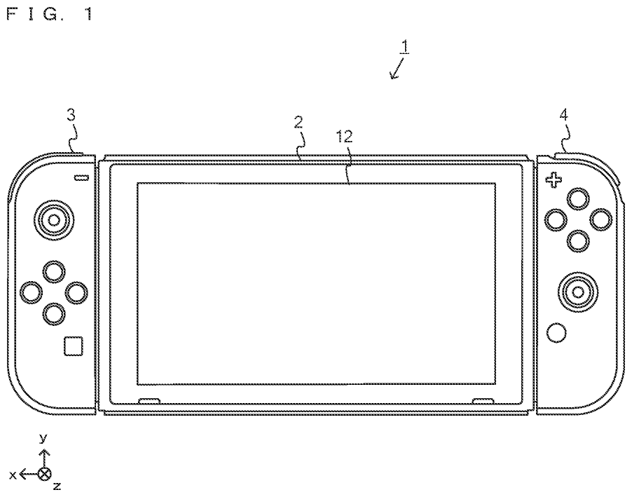

FIG. 1 is a diagram illustrating an example of a state in which the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating an example of a state in which each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

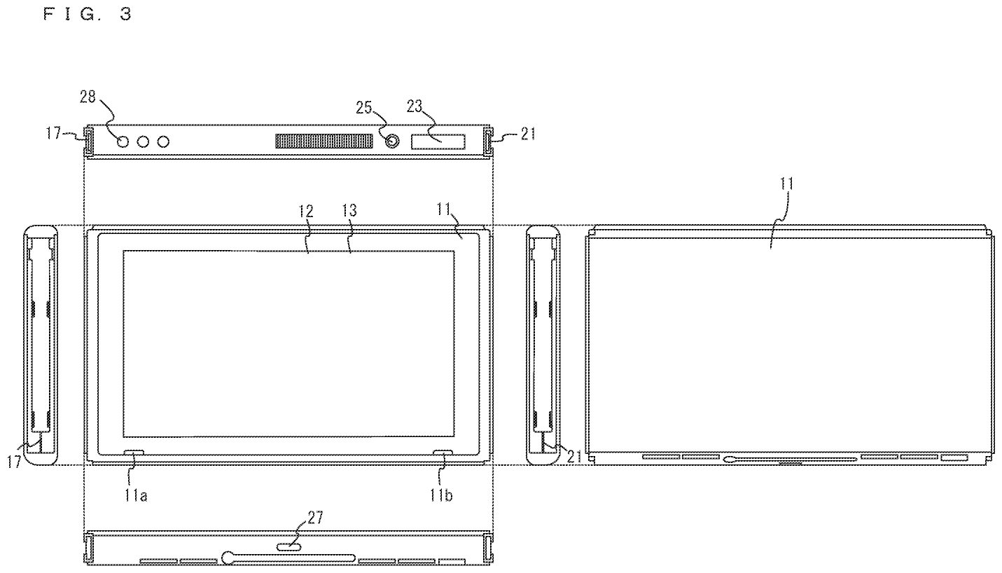

FIG. 3 illustrates six orthogonal views of an example of the main body apparatus 2. As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

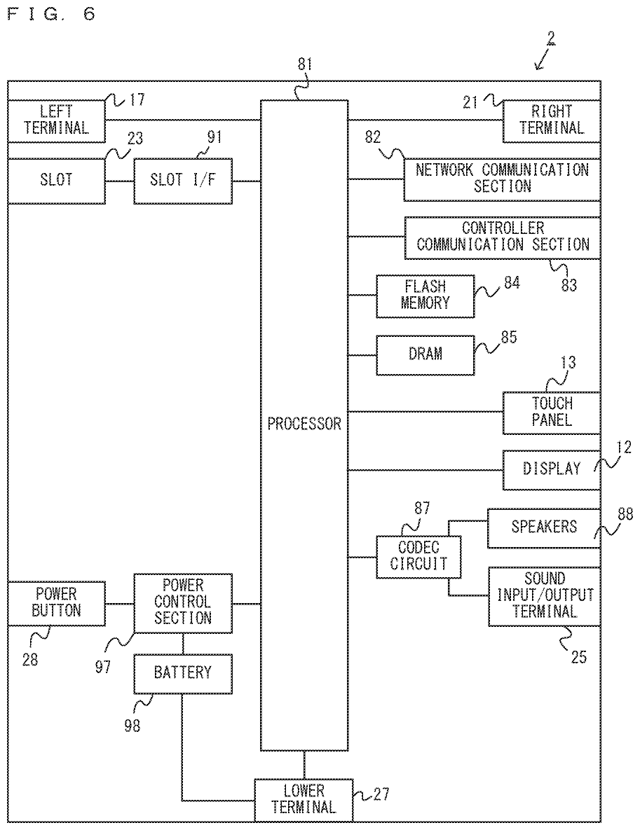

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

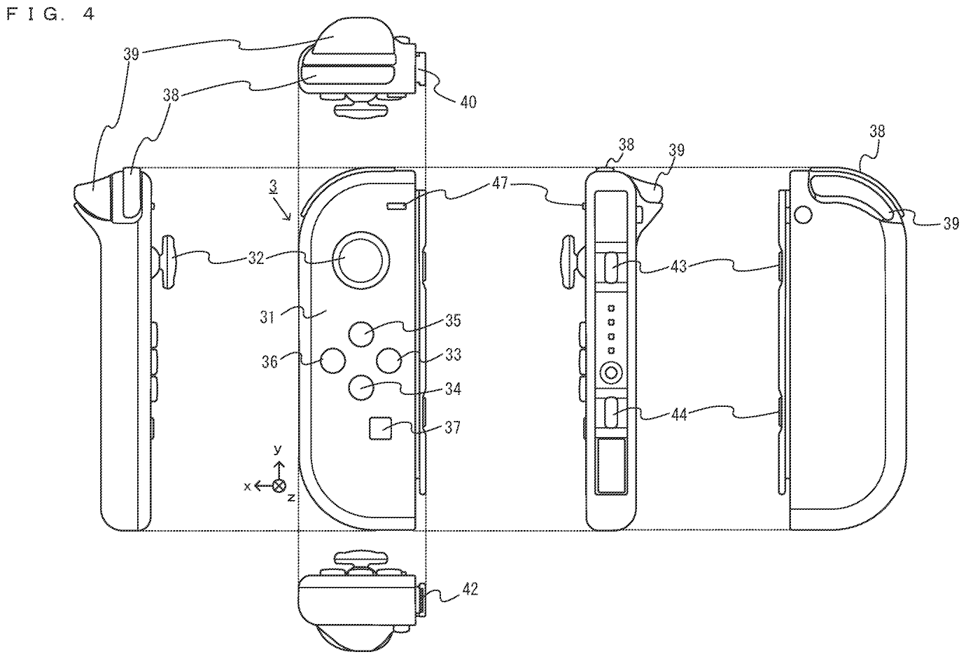

FIG. 4 illustrates six orthogonal views of an example of the left controller 3. As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

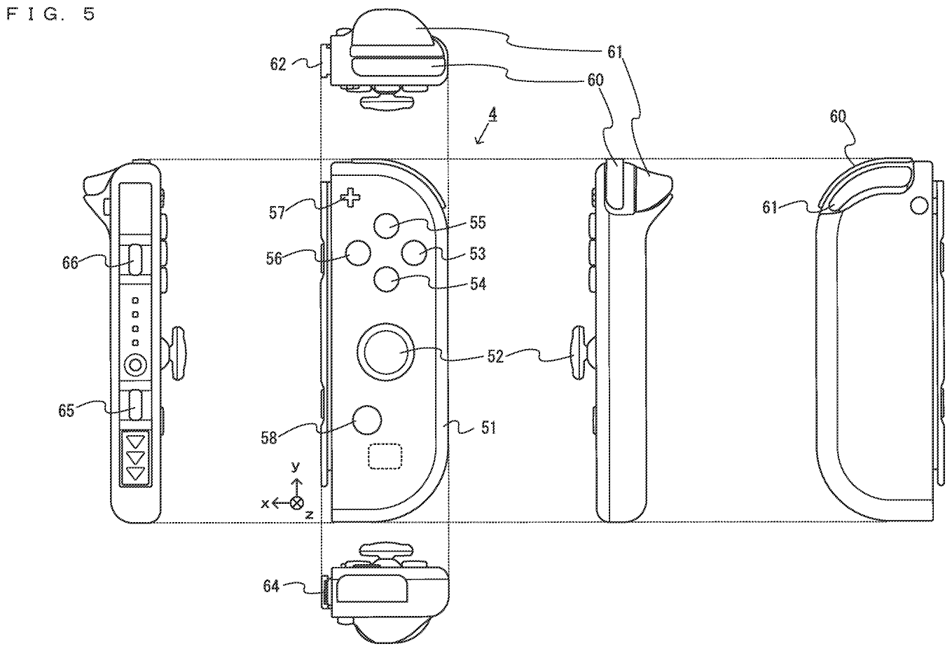

FIG. 5 illustrates six orthogonal views of an example of the right controller 4. As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating an example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

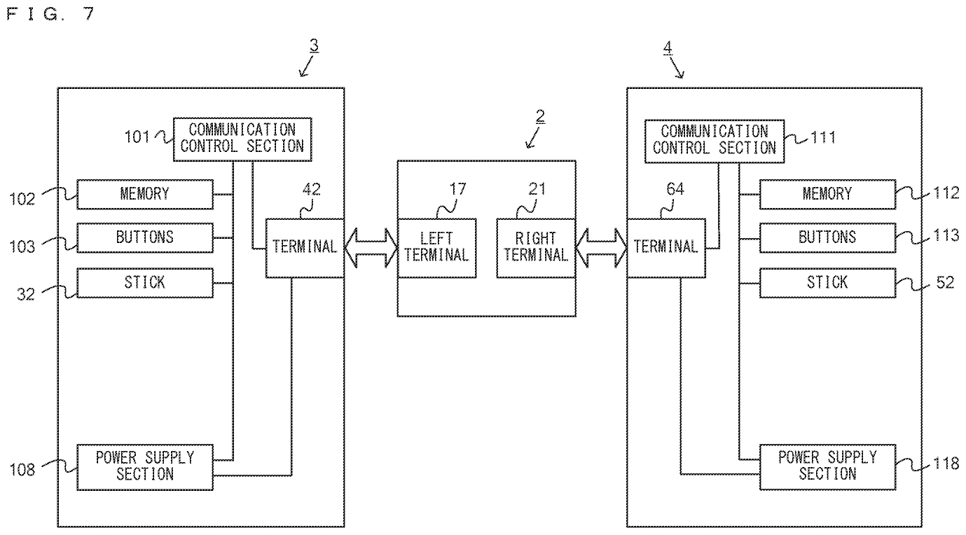

FIG. 7 is a block diagram illustrating examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing. The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a virtual space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs an action in a virtual space according to the user's operation performed using the operation buttons and the sticks.

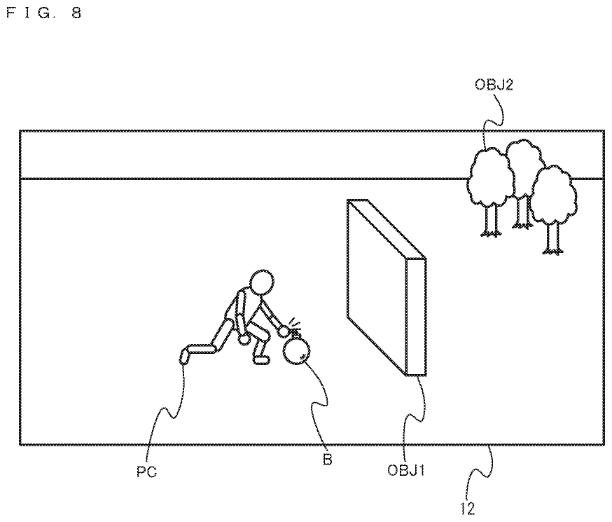

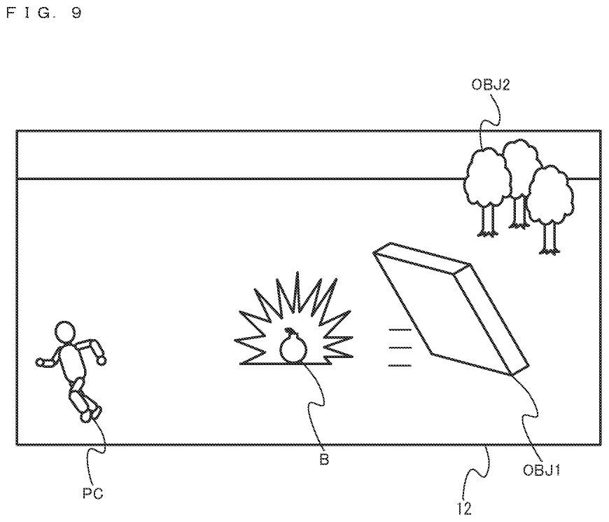

A first game process example in which a bomb item B alone explodes will be outlined with reference to FIGS. 8 and 9. It should be noted that FIG. 8 is a diagram illustrating an example of a game image showing that a player character PC activates a bomb item B in a virtual space. FIG. 9 is a diagram illustrating an example of a game image showing that a bomb item B activated by a player character PC explodes.

In FIG. 8, an image in which a player character PC, a bomb item B, a board-shaped object OBJ1, a tree object OBJ2, and the like are disposed on a game field in a virtual space is displayed on the display 12. The player character PC can move and perform an action on the game field in the virtual space based on the user's operation input. In addition, the bomb item B and the board-shaped object OBJ1 are a dynamic object that can be moved in the virtual space. Although, in the present example, it is assumed that game images are displayed on the display 12 of the main body apparatus 2, game images may be displayed on another display device connected to the main body apparatus 2.

The player character PC can move in the virtual space according to the user's movement operation input, and perform the actions of touching, hitting, and attacking other characters and virtual objects according to the user's action command operation input (e.g., an operation input of pressing down an operation button 53 (A-button)). As an example, control can be executed so as to cause the player character PC to perform an attack action using a weapon according to the user's attack command operation input.

In FIG. 8, the player character PC is trying to activate the bomb item B disposed on the game field in the virtual space by performing the action of hitting the bomb item B. The bomb item B is an item object that, when activated, transitions to an on-state that causes a phenomenon that the item object explodes in the virtual space. The operation states of the bomb item B include an on-state in which the bomb item B explodes and an off-state in which the bomb item B does not explode. The bomb item B is normally in the off-state, and can transition to the on-state either when the bomb item B exists alone in the virtual space or when the bomb item B is included as a part of an assembly object described below. For example, the player character PC performs a predetermined action (e.g., the action of approaching and hitting the bomb item B or the action of attacking the bomb item B) on the bomb item B existing alone in the virtual space according to the user's operation input. By the player character PC's predetermined action, the bomb item B is activated and transitions to the on-state. As an example, by the player character PC's first action (e.g., the action of approaching and hitting the bomb item B), the bomb item B transitions to the on-state, and then explodes after a predetermined time has passed since the first action, which is referred to as a timer explosion phenomenon. As another example, by the player character PC's second action (e.g., the action of attacking the bomb item B), the bomb item B transitions to the on-state and then immediately explodes, which is referred to as an instant explosion phenomenon. It should be noted that the player character PC's action for activating the bomb item B is not limited to the hitting or attacking action, and may be the player character PC's other actions.

Item objects in the present example including the bomb item B are a dynamic object that can be moved in the virtual space, and can be acquired on the field by the player character PC performing a predetermined acquisition action (e.g., the action of picking up an item object present on the field), and can be stored in the player character PC. As used herein, a state in which the player character PC stores an item object refers to a state in which the player character PC can carry an object such as an item object without being equipped with or holding the object. At this time, the item object may not be displayed on the game field. Stored item objects can be disposed on the game field and used (e.g., the player character PC is equipped with or holds such an item object), basically in appropriate situations, according to the user's operation input. As an example, for example, an item object is stored by being put into a pouch or item box. It should be noted that such a container may not be displayed. In addition, containers such as a pouch and an item box may not exist on the game field and only have the function of storing item objects.

It should be noted that item objects may be an object that has been previously disposed on the game field since the start of a game, an object that has been dropped by an opponent character, an object that has been disposed as a result of defeating an opponent character, or an object that has been obtained from an object other than item objects.

In FIG. 9, the bomb item B causes a phenomenon that the bomb item B explodes after a predetermined period of time has passed since activation of the bomb item B by the player character PC's action. For example, when the bomb item B explodes, an explosion thrust is applied as an influence of the explosion to other objects and characters that are disposed within a predetermined explosion range around the location where the explosion occurs. It should be noted that the explosion thrust caused by the explosion of the bomb item B is applied to all objects and characters that are disposed within the explosion range. An object or character that is either entirely or at least partially included in the explosion range may be considered as being disposed within the explosion range and may receive the explosion thrust. In addition, the explosion range is typically in the shape of a sphere around the location where the explosion occurs, or may have other shapes. In addition, the explosion range may be shaped so as to have a cut portion in which an influence of the explosion is blocked by a shield in the virtual space. In addition, the explosion range may have a predetermined fixed size, or may be changed, depending on the type of the bomb item B, the environment of the location where the explosion occurs, or the like.

In the example of FIG. 9, as the board-shaped object OBJ1 is disposed within the explosion range of the bomb item B when the bomb item B explodes, an explosion thrust is applied as an influence of the explosion to the board-shaped object OBJ1. On the other hand, as the tree object OBJ2 is disposed out of the explosion range of the bomb item B when the bomb item B explodes, the tree object OBJ2 does not come under an influence of the explosion. When the explosion thrust is applied to the board-shaped object OBJ1, an impact position where the explosion thrust acts on the board-shaped object OBJ1 is calculated. In addition, at this time, as the board-shaped object OBJ1 is a dynamic object that can be moved in the virtual space, a motion of the board-shaped object OBJ1 in the virtual space is set based on the explosion thrust, and the board-shaped object OBJ1 moves and flies in the virtual space from the location where the explosion occurs. It should be noted that an object that comes under an influence of the explosion of the bomb item B may be broken due to the explosion, depending on the weight, fixed state, strength, and the like thereof, and the location where the object is located in the virtual space may not be changed, or only the orientation of the object may be changed. In the present example, changes in the location and orientation or the state of an object to which the explosion thrust of the explosion is applied are calculated by physical calculation based on the explosion thrust. A method for calculating the applied explosion thrust and a method for calculating the location and orientation of an object are described below.

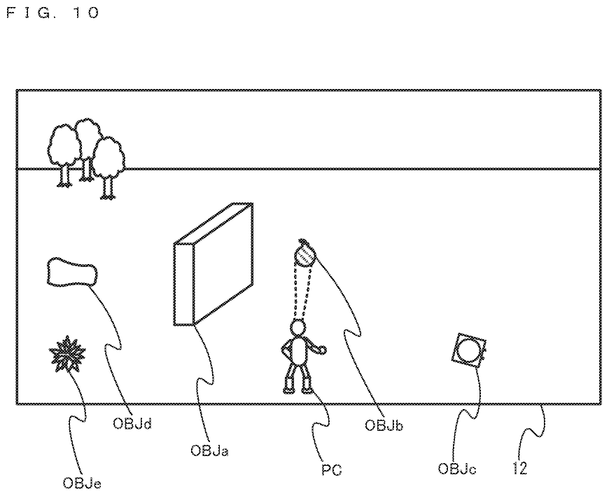

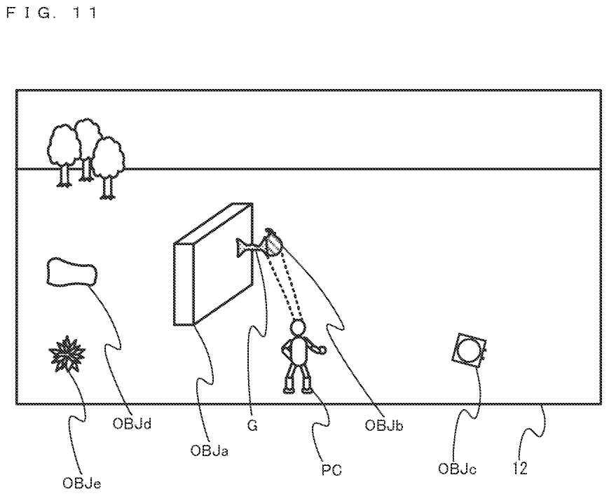

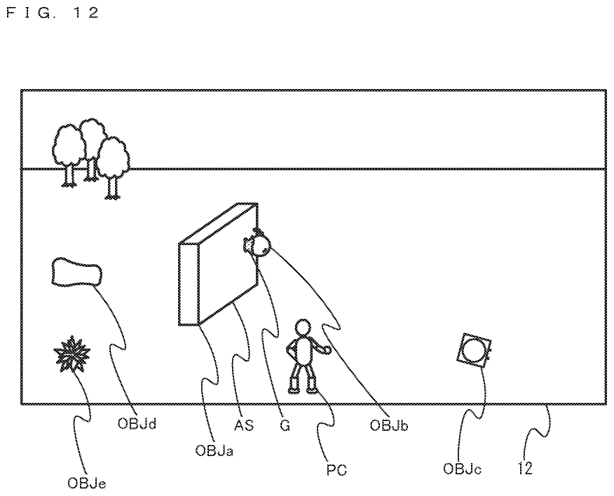

Next, a second game process example in which the player character PC generates an assembly object by an object operation action will be outlined with reference to FIGS. 10 to 12. It should be noted that FIG. 10 is a diagram illustrating an example of a game image showing that the player character PC causes an object to be controlled (operable object OBJb) to move, by an object operation action. FIG. 11 is a diagram illustrating an example of a game image showing that the player character PC attaches an object to be controlled (operable object OBJb) to an object OBJa. FIG. 12 is a diagram illustrating an example of a game image showing that the player character PC attaches an object to be controlled (operable object OBJb) to an object OBJa to generate an assembly object AS.

The player character PC can perform an object operation action as one of a plurality of actions that the player character PC performs according to the user's operation input. The object operation action is, for example, the action of remotely operating an operable object that is located in front of the player character PC as an object to be controlled. For example, one of a plurality of operable objects disposed in the virtual space is set as an object to be controlled by the object operation action, based on the user's operation input, and the movement and orientation of the object to be controlled in the virtual space are controlled. In addition, based on the object operation action, an object to be controlled is combined with and attached to another object disposed in the virtual space, so that an assembly object is generated.

It should be noted that some operable objects may be a dynamic object that can be moved in the virtual space by another action (e.g., the action of lifting an object) of the player character PC without the object operation action. Such another action can cause an operable object to move, and may not be able to put the operable object and another object together, unlike the object operation action. In addition, in the virtual space, objects that cannot be operated by the object operation action may be disposed. Examples of the objects that cannot be operated include terrain objects fixed in the virtual space such as rocks, mountains, built structures, and the ground. In addition, all dynamic objects that can be moved in the virtual space may be operated by the object operation action, or a portion of dynamic objects may not be able to be operated by the object operation action.

As illustrated in FIG. 10, when an operable object that may be an object to be controlled according to the object operation action is disposed in front of the player character PC (or in the vicinity of a gaze point of a virtual camera), then if a predetermined user's operation input is performed, the player character PC can perform the object operation action on the operable object. In the example of FIG. 10, an operable object OBJb (the bomb item B) is chosen as an object to be controlled from a plurality of operable objects OBJa to OBJe disposed in the virtual space, according to the user's predetermined choice operation input, and the object operation action is performed on the operable object OBJb. When the object operation action is being performed on the operable object OBJb, the operable object OBJb is floating above the ground of the virtual space, and is displayed in a form different from the normal form. Specifically, an operable object that is currently an object to be controlled may be displayed in a color different from those of the other objects, may be displayed with an effect image added thereto, or may be displayed with an effect image different from those of the other objects added thereto (it should be noted that in FIG. 10, a difference in display form is represented by hatching). In addition, in the present example, an effect image indicating that the object operation action is being performed is also displayed (it should be noted that in FIG. 10, the effect image is represented in a dashed line). Thus, when a game image showing a game field is displayed, one of objects on the game field that is an operable object as an object to be controlled by the object operation action, and the performance of the object operation action, can be presented to the user in a manner that allows those to be easily recognized by the user.

When, during the object operation action, the player character PC is moved according to the user's predetermined operation input (e.g., a direction operation input of tilting the analog stick 32 of the left controller 3), the operable object OBJb, which is currently an object to be controlled by the object operation action, is also moved. In addition, when, during the object operation action, the user's predetermined operation input (e.g., a direction operation input of tilting the analog stick 52 of the right controller 4) is performed, the orientation of the player character PC may be changed, and the operable object OBJb may be moved in the virtual space such that the object to be controlled is located in front of the player character PC. Furthermore, when, during the object operation action, the user's predetermined operation input (e.g., a direction operation input of pressing down direction keys 33 to 36) is performed, only the operable object OBJb, which is an object to be controlled, may be moved in the virtual space. Furthermore, when, during the object operation action, the user's predetermined operation input (e.g., an operation input of pressing down the direction keys 33 to 36 while pressing down an operation button 60 (R-button)) is performed, only the operable object OBJb, which is an object to be controlled, may be rotated in the virtual space.

As illustrated in FIG. 11, when the operable object OBJb is moved toward the object OBJa by the object operation action, then if the operable object OBJb and the object OBJa satisfy a predetermined connection condition (e.g., a distance between the two objects is less than a threshold), an attachment object G that connects the operable object OBJb to the object OBJa appears. Specifically, a position in a surface of the operable object OBJb that is closest to the object OBJa is set as one of attachment positions. Likewise, a position in a surface of the object OBJa that is closest to the operable object OBJb is set as the other of the attachment positions. The attachment object G is displayed as connecting these two attachment positions together.

As illustrated in FIG. 12, when the user performs an attach command operation input (e.g., an operation input of pressing down the operation button 53 (A-button)), the operable object OBJb and the object OBJa are attached together to generate an assembly object AS. As an example, the operable object OBJb and the object OBJa are attached together such that one of the attachment positions on the operable object OBJb is in contact with the other of the attachment positions on the object OBJa. Even after the operable object OBJb and the object OBJa are attached together, the attachment object G, which has been deformed into a gap shape due to the attachment, may remain at the attachment positions of these objects and may be displayed.

Thus, in the present example, the user is allowed to arbitrarily choose an operable object to be attached, attach the chosen operable object to another object at a position arbitrarily chosen by the user and in any orientation, to generate an assembly object. Therefore, in the present example, at least one dynamic object and at least one bomb item can be attached and joined together in the virtual space based on the user's operation input, and the movement of the resultant assembly object, which is a dynamic object, can be controlled based on physical calculation. Such an assembly object that functions as a dynamic object can be freely generated by the user. As used herein, the “attachment” of objects means that the objects are joined together with the objects located close to each other, and behave as an integrated object. For example, when two objects are attached together, the two objects may be in contact with each other. Alternatively, when two objects are attached together, the two objects may not exactly be in contact with each other. For example, there may be a space between the two objects, or the attachment object G may be interposed between the two objects. In addition, the term “a plurality of objects behave as an integrated object” includes the meaning that a plurality of objects move in the virtual space or change an orientation thereof, behaving as a single object, with a relative positional relationship thereof maintained. In other words, an assembly object obtained by joining a plurality of dynamic objects together is disposed as an integrated dynamic object in the virtual space. It should be noted that the relative positional relationship between a plurality of objects attached together may not entirely be fixed, and for example, may be slightly changed with these objects remained attached together when a force or impact is applied to any of the plurality of objects.

It should be noted that as described above, when the user performs an attachment removal operation input that satisfies a predetermined removal condition after a plurality of objects are attached together to generate an assembly object, the attachment of the virtual object may be removed. In addition, at least one priority attachment portion may be set for at least one of objects attached together. For example, priority attachment portions may be previously set for each object by a game creator, and when one object is attached to another object, a priority attachment portion closest to the attachment position may be attached with higher priority so that an assembly object is generated.

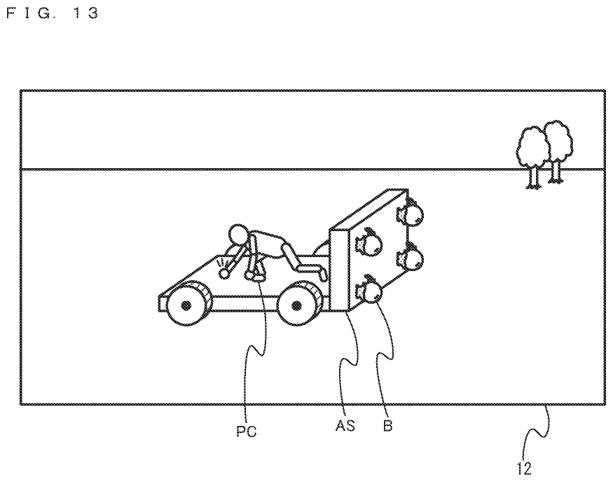

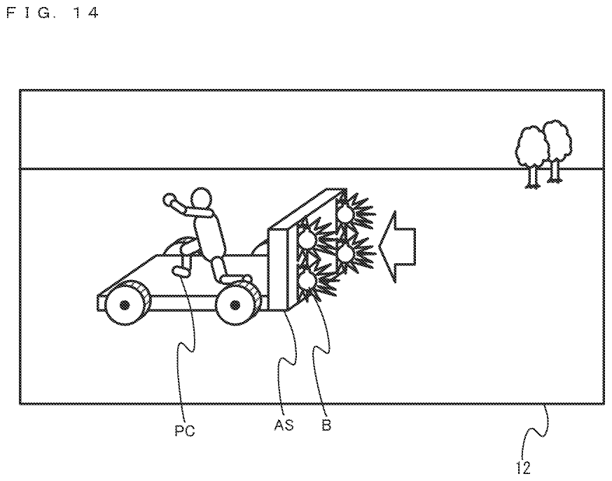

A third game process example in which a bomb item B included in an assembly object explodes will be outlined with reference to FIGS. 13 and 14. It should be noted that FIG. 13 is a diagram illustrating an example of a game image showing that the player character PC activates bomb items B included in an assembly object AS in the virtual space. FIG. 14 is a diagram illustrating an example of a game image showing an assembly object AS when bomb items B activated by the player character PC explode.

In FIG. 13, an assembly object AS is generated based on the object operation action, and a portion thereof is formed by a plurality of bomb items B. Specifically, the assembly object AS has a body formed by connecting two board-shaped objects together in an L-shape. The two board-shaped objects are joined together with one of the board-shaped objects in a horizontal position and the other in a vertical position (for the sake of convenience, one of the board-shaped objects joined together is referred to as the “front” part of the assembly object AS, and the other board-shaped object is referred to as the “rear” part of the assembly object AS). In addition, two wheel objects are joined to each of the left and right side surfaces of the horizontally-positioned board-shaped object, i.e., a total of four wheel objects are joined. The assembly object AS can be moved on the ground by these wheel objects rolling with the wheel objects in contact with the ground in the virtual space. In addition, four bomb items B are attached and fixed to the rear main surface of the vertically-positioned board-shaped object in the vicinity of four corners thereof.

An assembly object AS that is formed by attaching a plurality of objects together according to the object operation action behaves as an integrated object in the virtual space. In addition, if, when the player character PC is located in the vicinity of the assembly object AS, the user performs a predetermined action command operation input, the player character PC can get on the assembly object AS (e.g., the upper main surface of the horizontally-positioned board-shaped object). When a thrust is applied to the assembly object AS, the four wheel objects roll on the ground, so that the assembly object AS can move in the virtual space with the player character PC sitting thereon.

As illustrated in FIG. 13, the player character PC is trying to activate all of the bomb items B included in the assembly object AS by performing the action of hitting a portion of the assembly object AS (e.g., a portion thereof other than the bomb items B). The four bomb items B included in the assembly object AS transition to the on-state when an activation action is performed on the assembly object AS. For example, by the player character PC's first action on the assembly object AS (e.g., the action of hitting a portion of the assembly object AS, or the action of attacking a portion of the assembly object AS other than the bomb items B), all of the bomb items B included in the assembly object AS transition to the on-state, and explode all at once after a predetermined period of time has passed since the first action, which is referred to as a timer explosion phenomenon. As another example, by the player character PC's second action (e.g., the action of hitting or attacking any of the bomb items B included in the assembly object AS), the bomb item B undergoing the second action or all of the bomb items B included in the assembly object AS transition to the on-state and immediately explode, which is referred to as an instant explosion phenomenon. It should be noted that even when any of the bomb items B included in the assembly object AS transitions to the on-state due to the second action, the explosion of said bomb item B may induce the explosion of the other bomb items B, so that all of the bomb items B included in the assembly object AS may explode at substantially the same time. It should be noted that the player character PC's action that activates a bomb item B included in the assembly object AS is not limited to the action of hitting or attacking the assembly object AS, and may be the player character PC's other actions.

As illustrated in FIG. 14, when the bomb items B included in the assembly object AS transition to the on-state and explode, an explosion thrust occurs due to the explosion. For example, even when the bomb items B included in the assembly object AS explode, an explosion thrust is applied as an influence of the explosion to the object including the bomb items B (i.e., the assembly object AS) and other objects and the like that are disposed within a predetermined explosion range around the location where the explosion occurs. The explosion thrust acting on the assembly object AS acts on the rear main surface of the vertically-positioned board-shaped object, and transmits to the horizontally-positioned board-shaped object and the four wheel objects, so that the assembly object AS, including these objects, moves as an integrated object, in the virtual space with the player character PC sitting thereon. Even when the bomb items B included in the assembly object AS explode, an explosion thrust is applied as an influence of the explosion to other objects and characters that are disposed within a predetermined explosion range around the location where the explosion occurs.

In the example of FIG. 14, an explosion thrust is applied to the assembly object AS due to the explosion of each bomb item B included in the assembly object AS. For the assembly object AS, to which the explosion thrusts are applied, an impact position where each explosion thrust is applied is calculated, and a motion based on the explosion thrusts in the virtual space is set, so that the assembly object AS is moved in the virtual space in a direction away from the location where the explosion occurs. In the present example, when an explosion thrust caused by the explosion is applied to the assembly object AS, the movement direction and movement speed of the assembly object AS are calculated by physical calculation based on the explosion thrust. Although a plurality of explosions simultaneously have an impact on the assembly object AS, these explosions may be merged together and the resultant explosion may be used in the physical calculation, or the physical calculation may be executed for each explosion.

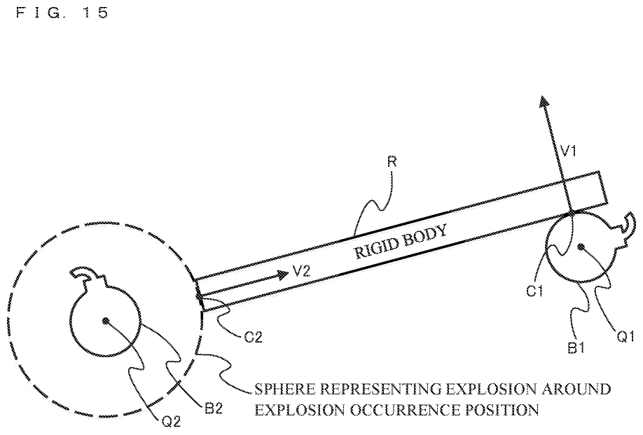

A method for calculating an explosion thrust caused by the explosion of a bomb item B and a method for calculating the location and orientation of an object to which an explosion thrust is applied will be described with reference to FIG. 15. It should be noted that FIG. 15 is a diagram illustrating an example of explosion thrusts applied to an object R.

In FIG. 15, an object R is a dynamic object that is a rigid body disposed in the virtual space and can be moved in the virtual space. Two bomb items B1 and B2 are disposed in the vicinity of the object R. Explosion thrusts that are applied to the object R when the bomb items B1 and B2 explode will be described as an example.

The bomb item B1 is disposed at a location where the bomb item B1 is in contact with a main surface of the object R in the vicinity of an end thereof, at a point C1. It should be noted that the point C1 is a location where a collision of the object R is in contact with a collision of the bomb item B1. More exactly, the point C1 is on the collision of the object R. When the bomb item B1 explodes, a position on the object R closest to an occurrence position Q1 where the explosion occurs is calculated as an impact position of an explosion thrust caused by the explosion. In the case of the bomb item B1 of FIG. 15, the impact position is a position where the position on the object R closest to the occurrence position Q1, which is the center or barycenter of the bomb item B1, is in contact with the bomb item B1, i.e., the point C1. In addition, the explosion thrust caused by the explosion of the bomb item B1 is calculated as a force that occurs when a point having a first mass hits an impact position (the point C1) on the object R at a first speed in a direction from the occurrence position Q1 toward the impact position (the point C1). Physical determination of the explosion thrust may be triggered by the explosion, and may be executed such that the explosion thrust acts on the object R only in a frame in which the explosion occurs. In addition, assuming that the explosion thrust by the physical determination occurs on the object R at the time when the bomb item B1 explodes, the location and orientation of the object R after the explosion are calculated based on physical calculation. For example, by physical calculation based on a force applied to the object R (including an explosion thrust or a thrust that occurs when the object R is moving), another object's impact on the object R, or the like, the movement of the object R (the movement speed, movement acceleration, movement angular speed, movement angular acceleration, movement direction, and the like) is calculated, and the location and orientation of the object R are updated with those after the explosion.

The bomb item B2 is located at a position that is away from a side surface at the other end of the object R. When the bomb item B2 explodes, a position on the object R that is closest to an occurrence position Q2 where the explosion occurs is calculated as an impact position of an explosion thrust caused by the explosion. In other words, when an explosion occurs at a location away from the object R like the bomb item B2, a position closest to the occurrence position Q2 of the explosion can be considered as a position that first touches the object R when a sphere representing the explosion around the occurrence position Q2 is gradually enlarged. Therefore, in the case of the bomb item B2 of FIG. 15, the impact position is a point C2. It should be noted that the point C2 is a position where a collision of the object R is in contact with the sphere representing the explosion, and therefore, exactly speaking, a position on the collision of the object R. In addition, the explosion thrust caused by the explosion of the bomb item B2 is calculated as a force that occurs when a point having a second mass hits the object R at an impact position thereon (the point C2) at a second speed in a direction from the occurrence position Q2 toward the impact position (the point C2). Physical determination of the explosion thrust may be triggered by the explosion, and may be executed such that the explosion thrust acts on the object R only in a frame in which the explosion occurs. In addition, assuming that the explosion thrust by the physical determination occurs on the object R at the time when the bomb item B2 explodes, the location and orientation of the object R after the explosion are calculated based on physical calculation.

Thus, when the object R is moved due to the occurrence of an explosion by physical determination of a bomb thrust, the location and orientation of the object R are calculated based on physical calculation, assuming that a point having a predetermined mass (first or second mass) hits the object R at a predetermined speed (first or second speed) in a direction from the occurrence position Q of the explosion toward an impact position (point C) on the object R closest to the occurrence position Q. Therefore, the object R can be moved in a direction close to that which is intuitively expected from the explosion occurrence position. In addition, such physical calculation of a bomb thrust is similarly executed for an assembly object obtained by joining a plurality of objects together. It should be noted that by calculating a force applied to each object based on an interaction between the objects joined together, all objects constituting the assembly object may be moved together, or the assembly object may be calculated as a single integrated object. In addition, by physical calculation based on a force applied to the assembly object (including an explosion thrust and a thrust that occurs when the assembly object is moving), an impact of another object on the assembly object, and the like, the movement of the assembly object (the movement speed, movement acceleration, movement angular speed, movement angular acceleration, movement direction, and the like) is calculated, and the location and orientation of the assembly object are updated with those after the explosion. In the case of the assembly object, a bomb item B may be fixed to the assembly object at any position and caused to explode, and therefore, the user may previously dispose a bomb item B that can cause the assembly object to move in a desired direction due to the explosion.

It should be noted that the moment of inertia tensor of the object R may be temporarily increased only for a frame in which the explosion, for which the physical determination of the explosion thrust is executed, occurs. As a result, for a moment of the explosion, a change in the direction due to factors such as a load other than the explosion can be inhibited, and therefore, the object R can be inhibited from moving from the explosion occurrence position in a direction different from that which is intuitively expected by the user. It should be noted that the period of time during which the moment of inertia tensor of the object R is temporarily increased is not limited to a frame, and may be temporarily increased for a plurality of frames from the occurrence of the explosion.

In addition, the first and second speeds that are used in the physical determination of an explosion thrust may be set based on the magnitude or type of an explosion, and may be decreased according to the distance between the explosion occurrence position and the explosion impact position (in the case of the first speed: the distance between the occurrence position Q1 and the impact position (the point C1), and in the case of the second speed: the distance between the occurrence position Q2 and the impact position (the point C2)). In addition, the first and second masses that are used in the physical determination of an explosion thrust may be set based on the magnitude or type of an explosion, and may be decreased according to the distance between the explosion occurrence position and the explosion impact position (in the case of the first mass: the distance between the occurrence position Q1 and the impact position (the point C1), and in the case of the second mass: the distance between the occurrence position Q2 and the impact position (the point C2)).

In addition, in the present example, a plurality of explosions can occur like the explosion of the bomb item B1 and the explosion of the bomb item B2. It should be noted that these explosions may occur at the same or different times. In addition, when a plurality of explosions occur at the same time and thrusts caused by the explosions are applied to the same object, the explosion thrusts may be merged and the resultant thrust may be used in the physical calculation, or each explosion thrust may be directly used in the physical calculation.

In addition, the physical determination of an explosion thrust may be executed simultaneously with the explosion, or after a predetermined period of time has passed since the explosion. In the latter case, the delay in executing the physical determination after the explosion may be set to a period of time that increases with an increase in the distance between the explosion occurrence position and the explosion impact position. In addition, the physical determination of an explosion thrust is not limited to an embodiment in which the explosion thrust is applied to the object R only for a frame involved with the explosion, or alternatively, the explosion thrust may be applied to the object R for a plurality of frames after the occurrence of the explosion. In the latter case, the number of frames in which the physical determination of the explosion thrust is applied to the object R (the number of times a process is executed) may be set to a value that decreases with an increase in the distance between the explosion occurrence position and the explosion impact position.

In addition, the present example is applicable not only to examples in which an explosion thrust caused by the explosion of a bomb item B is applied to an object, but also to examples in which thrusts generated by explosion, blast, electric discharge, radiation, and scattering caused by explosion sources such as other objects and characters such as bomb flowers and bomb insects, phenomena such as lightning, attacks using weapons such as artilleries and bomb arrows, and the like, can be applied to objects in the virtual space. It should be noted that for explosions caused by explosion sources other than bomb items B, a predetermined explosion range is set, where the center or barycenter of the explosion source is the occurrence position. In the case of explosions caused by the above explosion sources, all objects and characters that are disposed within the explosion range of the explosion are also subject to an explosion thrust caused by the explosion. An object or character that is either entirely or at least partially included in the explosion range may be considered as being disposed within the explosion range and may receive the explosion thrust. In addition, the explosion range of the explosion of the above explosion sources is typically in the shape of a sphere around the location where the explosion occurs, or may have other shapes. In addition, the explosion range of the explosion of the above explosion sources may be shaped so as to have a cut portion in which an influence of the explosion is blocked by a shield in the virtual space. In addition, the explosion range of the explosion of the above explosion sources may have a predetermined fixed size, or may be changed, depending on the type of the bomb source, the environment of the location where the explosion occurs, or the like.

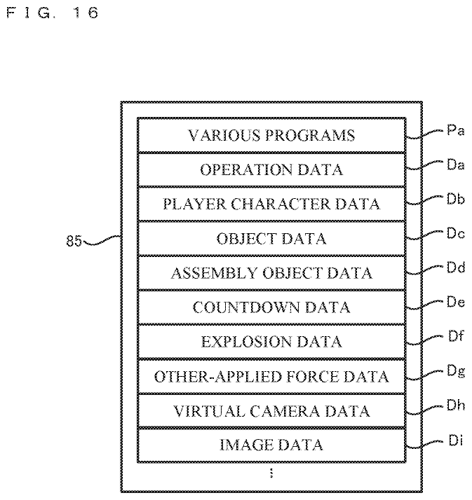

Next, an example of a specific process that is executed in the game system 1 will be described with reference to FIG. 16. FIG. 16 is a diagram illustrating an example of a data area set in the DRAM 85 of the main body apparatus 2. It should be noted that in addition to the data of FIG. 16, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, player character data Db, object data Dc, assembly object data Dd, countdown data De, explosion data Df, other-applied force data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The player character data Db indicates the location, direction, and pose, and an action and state (including movement parameters such as a movement speed) in the virtual space, of the player character PC located in the virtual space, and the like.

The object data Dc indicates the location, orientation, and pose, and action and state in the virtual space (including a parameter indicating whether each object is the on-state or the off-state, and parameters such as a speed, acceleration, angular speed, angular acceleration, and moment of inertia tensor), and the like of each object (including each object included in an assembly object) disposed in the virtual space.

The assembly object data Dd indicates the configuration and structure, and location, orientation, and pose in the virtual space, and action and state in the virtual space (including parameters such as a speed, acceleration, angular speed, angular acceleration, and moment of inertia tensor), and the like of an assembly object disposed in the virtual space.

The countdown data De indicates a count that is a period of time measured from the activation of each bomb item B until the explosion thereof.

The explosion data Df indicates the occurrence position and explosion range of an explosion occurring in the virtual space, and an explosion thrust (an explosion impact position, explosion direction, explosion mass, explosion speed, and the like) applied to each object in the explosion range.

The other-applied force data Dg indicates forces that are applied to each object in the virtual space due to phenomena other than explosions.

The virtual camera data Dh indicates the location, direction, angle of view, and the like of a virtual camera disposed in the virtual space.

The image data Di is for displaying an image (e.g., an image of the player character PC, an image of each object, an image of another character, an image of each assembly object, an image of a field of the virtual space, and a background image) on a display screen (e.g., the display 12 of the main body apparatus 2).

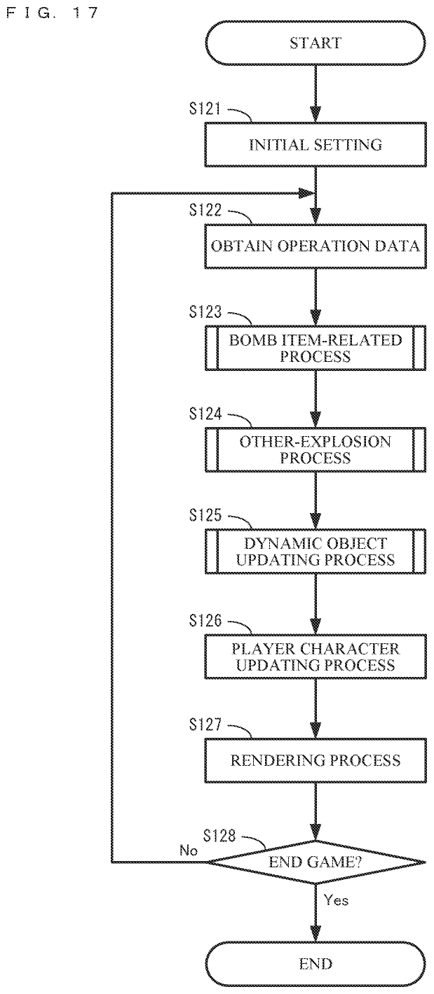

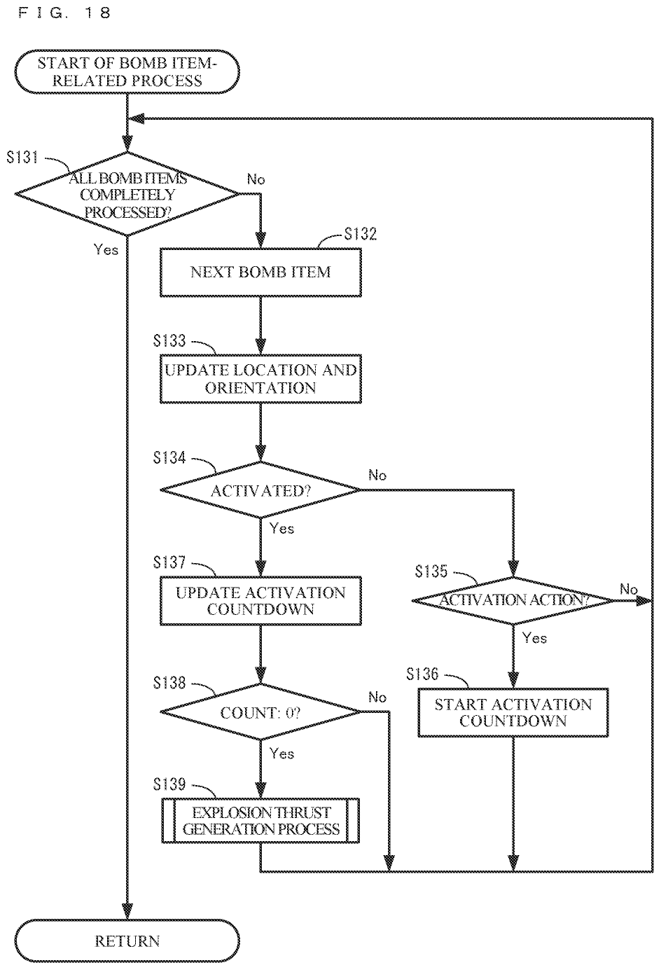

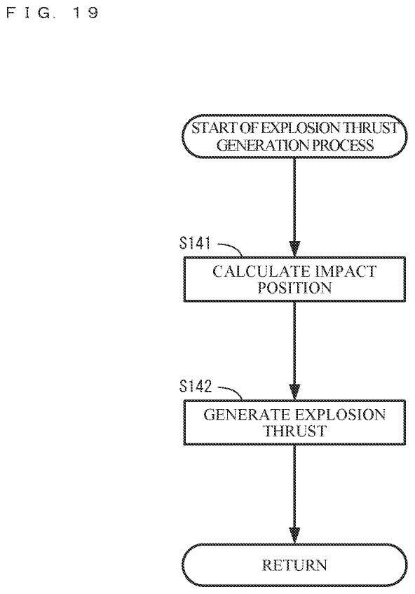

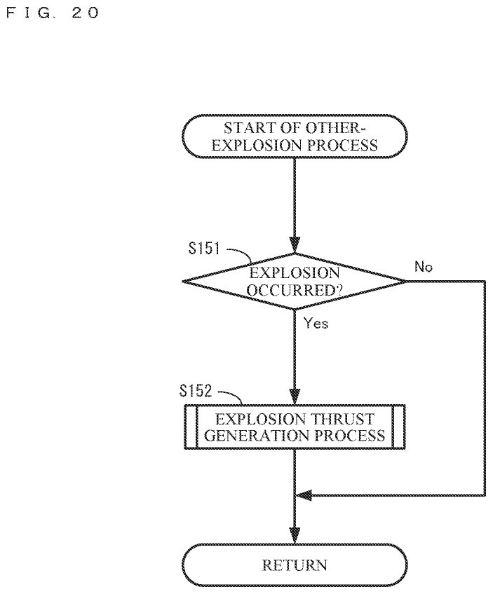

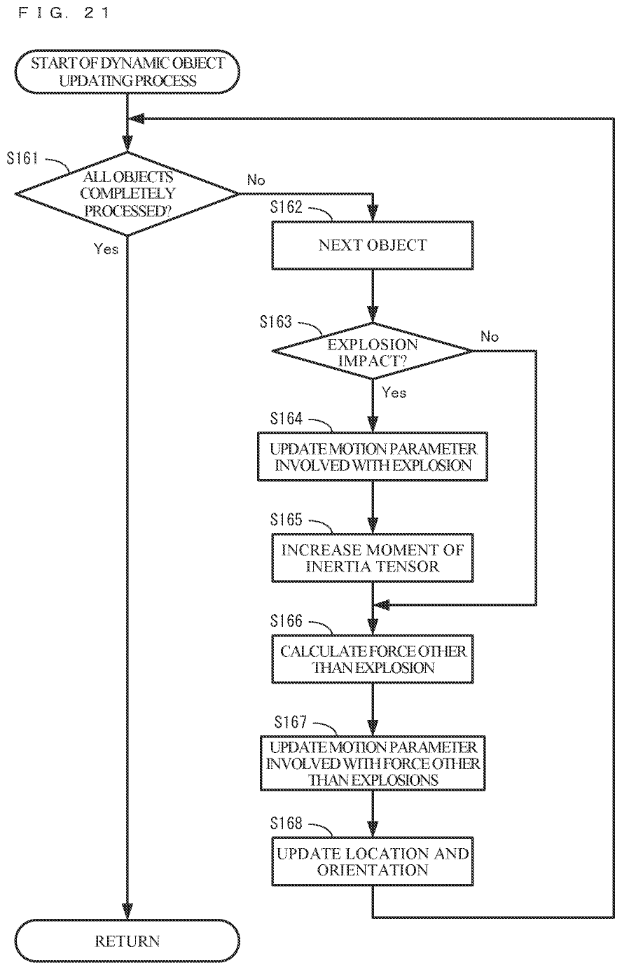

Next, a detailed example of a game process that is an example of an information process in the present example will be described with reference to FIGS. 17 to 21. FIG. 17 is a flowchart illustrating an example of a game process that is executed in the game system 1. FIG. 18 is a subroutine illustrating an example of a bomb item-related process in step S123 of FIG. 17. FIG. 19 is a subroutine illustrating an example of an explosion thrust generation process in step S139 of FIG. 18 and step S152 of FIG. 20. FIG. 20 is a subroutine illustrating an example of an other-explosion process in step S124 of FIG. 17. FIG. 21 is a subroutine illustrating an example of a dynamic object updating process in step S125 of FIG. 17. In the present example, a series of steps illustrated in FIGS. 17 to 21 are executed by the processor 81 executing a predetermined application program (game program) included the programs Pa. The game process of FIGS. 17 to 21 is started with any appropriate timing.

It should be noted that the steps in the flowcharts of FIGS. 17 to 21, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., a server that can communicate with the main body apparatus 2 via a network). Specifically, the steps of FIGS. 17 to 21 may be executed by a plurality of information processing apparatuses including the main body apparatus 2 cooperating with each other.

In FIG. 17, the processor 81 executes initial setting for the game process (step S121), and proceeds to the next step. For example, in the initial setting, the processor 81 initializes parameters for executing steps described below, and updates each data. As an example, the processor 81 disposes objects, characters, and the like in a game field of the virtual space to generate an initial state of the virtual space, and updates the object data Dc and the assembly object data Dd. In addition, the processor 81 disposes a player character PC and a virtual camera in a predetermined pose and orientation at default locations in the virtual space in the initial state, and updates the player character data Db and the virtual camera data Dh.

Next, the processor 81 obtains operation data from the left controller 3, the right controller 4, and/or the main body apparatus 2, updates the operation data Da (step S122), and proceeds to the next step.

Next, the processor 81 executes a bomb item-related process (step S123), and proceeds to step S124. The bomb item-related process in step S123 will be described below with reference to FIG. 18.

In FIG. 18, the processor 81 determines whether or not all bomb items B (including bomb items B included in an assembly object) disposed in the virtual space have been processed (step S131). If not all the bomb items B have been processed, the processor 81 proceeds to step S132. Otherwise, i.e., if all the bomb items B have been processed, the processor 81 ends the subroutine.

In step S132, the processor 81 chooses one that has not been processed from all the bomb items B disposed in the virtual space, and proceeds to the next step.

Next, the processor 81 updates the location and orientation of the bomb item B of interest in the virtual space (step S133), and proceeds to the next step. As an example, when the bomb item B of interest is being moved by the player character PC's action, the processor 81 moves the bomb item B based on the player character PC's action updated in step S126 in the previous frame, and updates the object data Dc using the location and orientation after the movement. As another example, when the bomb item B is being moved based on a physical law in the virtual space, the processor 81 moves the bomb item B based on physical calculation in the virtual space, and updates the object data Dc using the location and orientation after the movement.

Next, the processor 81 determines whether or not the bomb item B of interest has been activated (step S134). For example, if the object data Dc indicates that the bomb item B of interest is in the on-state, the result of the determination by the processor 81 in step S134 is positive. If the bomb item B of interest has not been activated, the processor 81 proceeds to step S135. Otherwise, i.e., if the bomb item B of interest has been activated, the processor 81 proceeds to step S137.

In step S135, the processor 81 determines whether or not the player character PC has performed an activation action on the bomb item B of interest. For example, if the player character PC's action updated in step S126 in the previous frame is an action for activating the bomb item B of interest, the result of the determination by the processor 81 in step S135 is positive. If the player character PC has performed the activation action on the bomb item B of interest, the processor 81 proceeds to step S136. Otherwise, i.e., if the player character PC has not performed the activation action on the bomb item B of interest, the processor 81 returns to and repeats step S131.

In step S136, the processor 81 starts activation countdown, and returns to and repeats step S131. For example, the processor 81 causes the state of the bomb item B of interest to transition to the on-state, updates the object data Dc, sets a count indicating a period of time from the activation of the bomb item B until the explosion thereof, and updates the countdown data De of the bomb item B, and thereby, starts a countdown process of the bomb item B.

In step S137, the processor 81 updates the activation countdown, and proceeds to the next step. For example, the processor 81 decreases the count of the bomb item B of interest by one, and updates the countdown data De of the bomb item B.

Next, the processor 81 determines whether or not the count of the bomb item B of interest is zero (step S138). If the count of the bomb item B of interest is zero, the processor 81 proceeds to step S139. Otherwise, i.e., if the count of the bomb item B of interest is not zero, the processor 81 returns to and repeats step S131.

In step S139, the processor 81 executes an explosion thrust generation process, and returns to and repeats step S131. The explosion thrust generation process in step S139 will be described below with reference to FIG. 19.

In FIG. 19, the processor 81 sets a new explosion whose explosion source is the bomb item B of interest or the like, calculates an impact position of the explosion (step S141), and proceeds to the next step. For example, the processor 81 sets a new explosion having a predetermined explosion range around the barycenter or center of an explosion source such as the bomb item B of interest, as an explosion occurrence position, causes the explosion source such as the bomb item B to disappear, and updates the object data Dc and the explosion data Df. Thereafter, the processor 81 calculates the impact position of the new explosion for each object within the set explosion range, and updates the explosion data Df. It should be noted that methods for setting the explosion occurrence position, explosion range, and explosion impact position are similar to those described above, and will not herein be described in detail.

Next, the processor 81 generates an explosion thrust of the new explosion (step S142), and ends the subroutine. For example, the processor 81 generates physical determination (explosion thrust) including an explosion mass, explosion speed, and explosion direction that act on the impact position of each object set in step S141, and updates the explosion data Df. It should be noted that methods for calculating an explosion mass, explosion speed, and explosion direction are similar to those described above with reference to FIG. 15 and the like, and will not herein be described in detail.

Referring back to FIG. 17, after the bomb item-related process in step S123, the processor 81 executes an other-explosion process (step S124), and proceeds to step S125. The other-explosion process in step S124 will be described below with reference to FIG. 20.

In FIG. 20, the processor 81 determines whether or not a new explosion whose explosion source is not the bomb item B has occurred (step S151). If a new explosion whose explosion source is not the bomb item B has occurred, the processor 81 proceeds to step S152. Otherwise, i.e., if a new explosion whose explosion source is not the bomb item B has not occurred, the processor 81 ends the subroutine.

In step S152, the processor 81 executes an explosion thrust generation process on the explosion that it is determined in step S151 that has newly occurred, and ends the subroutine. It should be noted that the explosion thrust generation process executed in step S152 is similar to the explosion thrust generation process described above with reference to FIG. 19, and will not herein be described in detail.

Referring back to FIG. 17, after the other-explosion process in step S124, the processor 81 executes a dynamic object updating process (step S125), and proceeds to step S126. The dynamic object updating process in step S125 will be described below with reference to FIG. 21.

In FIG. 21, the processor 81 determines whether or not all dynamic objects (including an assembly object) disposed in the virtual space have been processed (step S161). If not all dynamic objects have been processed, the processor 81 proceeds to step S162. Otherwise, i.e., if all dynamic objects have been processed, the processor 81 ends the subroutine.

In step S162, the processor 81 chooses one that has not been processed from all dynamic objects disposed in the virtual space, and proceeds to the next step.

Next, the processor 81 determines whether or not a new explosion impact has occurred on the dynamic object of interest (step S163). For example, if physical determination (explosion thrust) has been generated by the new explosion for the dynamic object of interest by the explosion thrust generation process in step S139 or S152, the result of the determination by the processor 81 in step S163 is positive. If a new explosion impact has occurred on the dynamic object of interest, the processor 81 proceeds to step S164. Otherwise, i.e., if a new explosion impact has not occurred on the dynamic object of interest, the processor 81 proceeds to step S166.

In step S164, the processor 81 updates a motion parameter involved with an explosion having an impact on the dynamic object of interest, and proceeds to the next step. For example, the processor 81 calculates a motion parameter (a speed, acceleration, angular speed, angular acceleration, or the like) of the dynamic object of interest involved with an influence of the explosion thrust (physical determination) set for the dynamic object of interest, with reference to the explosion data Df, and updates the object data Dc or the assembly object data Dd. It should be noted that when a plurality of explosions have newly occurred on the dynamic object of interest, the plurality of explosions may be merged together and the resultant explosion may be subjected to the above process, or the motion may be calculated for each explosion.

Next, the processor 81 temporarily increases the moment of inertia tensor of the dynamic object of interest (step S165), and proceeds to step S166. For example, the processor 81 increases the moment of inertia tensor of the dynamic object of interest only for the current frame (until the end of step S168 described below) by a predetermined amount, and updates the object data Dc or the assembly object data Dd.

In step S166, the processor 81 calculates all forces that are applied to the dynamic object of interest due to any phenomena other than explosions, and proceeds to the next step. For example, the processor 81 generates physical determination of all forces applied to the dynamic object of interest in the virtual space, and updates the other-applied force data Dg. Here, forces that are applied to a dynamic object due to any phenomena other than explosions include various forces received from the surroundings of the dynamic object in the virtual space, such as a force (load) caused by another object's attack, an inertial force caused by movement or vibration in the virtual space, an impact force or frictional force caused by impact or contact with another object, a character, a field, or the like, a gravity caused by the weight of the dynamic object itself and the weight of another object or a character on the dynamic object, and a pressure caused by various phenomena occurring in the virtual space.

Next, the processor 81 updates a motion parameter of the dynamic object of interest involved with a force other than explosions (step S167), and proceeds to the next step. For example, the processor 81 calculates a motion parameter (a speed, acceleration, angular speed, angular acceleration, or the like) of the dynamic object of interest involved with an influence of a force (physical determination) other than explosions set for the dynamic object of interest, with reference to the other-applied force data Dg, and updates the object data Dc or the assembly object data Dd. It should be noted that if motion parameters involved with a plurality of forces including an explosion thrust have been calculated for the dynamic object of interest, these motion parameters may be cancelled out or added up into a single motion parameter.

Next, the processor 81 updates the location and orientation of the dynamic object of interest in the virtual space (step S168), and returns to and repeats step S161. For example, the processor 81 obtains the location, direction, orientation, motion parameter, and moment of inertia tensor of the dynamic object of interest in the virtual space, with reference to the object data Dc or the assembly object data Dd. Thereafter, the processor 81 executes physical calculation based on the obtained parameters to move the dynamic object in the virtual space, and updates the object data Dc or the assembly object data Dd using the location, direction, and orientation after the movement.

Referring back to FIG. 17, after the dynamic object updating process in step S125, the processor 81 executes a player character updating process (step S126), and proceeds to the next step. For example, the processor 81 sets the player character PC's action based on the operation data Da. As an example, the processor 81 sets the location, direction, pose, action, state, and the like of the player character PC based on the user's operation input indicated by the operation data Da, virtual physical calculation (e.g., a virtual inertia or gravity) in the virtual space, and the like, and updates the player character data Db.

The player character PC's action includes the object operation action. When the player character PC performs the object operation action, the processor 81 updates the player character data Db, and executes a process of attaching an operable object that is an object to be controlled by the object operation action to another object to generate an assembly object. If an assembly object is generated, the processor 81 updates the assembly object data Dd using the configuration, structure, location, direction, and orientation of the assembly object. It should be noted that a method for generating an assembly object is similar to the method described above with reference to FIGS. 10 to 12, and will not herein be described in detail.

In addition, the player character PC's action includes an action for activating a bomb item B. For example, when the player character PC performs the action of approaching and hitting a bomb item B or the action of attacking a bomb item B, the bomb item B that is the target of the action is activated and transitions to the on-state. In addition, when the player character PC performs the action of hitting an assembly object including at least one bomb item B, all bomb items B included in the assembly object are activated and transition to the on-state. When the player character PC executes an action for activating any of the bomb items B, the processor 81 updates the player character data Db, executes step S136 as a result of the determination in step S135, which is positive, in the next frame, and starts the activation countdown process on the activated bomb item B.

In addition, the player character PC's action includes the player character PC's action for obtaining an item object such as a bomb item B, and the like. For example, when the player character PC performs an action for obtaining an item object, the processor 81 executes a process of adding the item object obtained by the action to the player character PC, which in turn stores the item object.

Next, the processor 81 executes a rendering process (step S127), and proceeds to the next step. For example, the processor 81 disposes the player character PC, objects, an assembly object, and the like in the virtual space based on the player character data Db, the object data Dc, and the assembly object data Dd. In addition, the processor 81 sets the location and/or orientation of a virtual camera for generating a display image based on the virtual camera data Dh, to dispose the virtual camera in the virtual space. Thereafter, the processor 81 generates an image of the virtual space as viewed from the set virtual camera, and executes control such that the virtual space image is displayed on the display 12. It should be noted that the processor 81 may execute a process of controlling the movement of the virtual camera in the virtual space based on the location and pose of the player character PC, and update the virtual camera data Dh. In addition, the processor 81 may move the virtual camera in the virtual space based on the operation data Da, and update the virtual camera data Dh.

Next, the processor 81 determines whether or not to end the game process (step S128). In step S128, the game process is ended, for example, if a condition for ending the game process is satisfied, the user has performed an operation of ending the game process, or the like. If the processor 81 determines not to end the game process, the processor 81 returns to and repeats step S122. Otherwise, i.e., if the processor 81 determines to end the game process, the processor 81 ends the flowchart. Following this, steps S122 to S128 are repeatedly executed until the processor 81 determines to end the game process in step S128.

Thus, in the present example, when a dynamic object is moved by causing a bomb item B to explode in the virtual space, the location and orientation of the dynamic object are calculated based on physical calculation, assuming that a point having a predetermined mass hits the dynamic object at a predetermined speed in a direction from an explosion occurrence position to an impact position on the dynamic object closest to the explosion occurrence position. Therefore, the dynamic object can be moved in a direction close to that which is intuitively expected from the explosion occurrence position.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of step S may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is applicable as a game program, game system, game apparatus, and game processing method that allow the user to move an object or the like in a virtual space in the direction that is intuitively expected or intended from an explosion occurrence position.

What is claimed is:

1. A non-transitory computer-readable storage medium having stored therein instructions that, when executed, cause one or more processors of an information processing apparatus to execute game processing comprising:
executing movement control on at least one movable, dynamic object in a virtual space based on physical calculation;
generating at least one explosion with timing based on a game process; and
when the at least one explosion occurs, calculating a location and orientation of a target object present within a range from an occurrence position where each explosion occurs, based on physical calculation, assuming that a position on the target object closest to the occurrence position is an impact position, and if the target object is the dynamic object, a point having a first mass hits the target object at the impact position at a first speed in a direction from the occurrence position toward the impact position.

2. The non-transitory computer-readable storage medium according to claim 1, wherein
the dynamic object includes a bomb object, and
the game processing further comprises:
joining at least one of the bomb objects to at least one of the dynamic objects in the virtual space based on an operation input to obtain an assembly object, which is a dynamic object, and executing movement control on the assembly object based on the physical calculation; and
generating the explosion at a location of the bomb object with timing specified based on an operation input.

3. The non-transitory computer-readable storage medium according to claim 2, wherein
the bomb object explodes after a period of time has passed since performance of an operation input of commanding to explode.

4. The non-transitory computer-readable storage medium according to claim 3, wherein
the game processing further comprises:
controlling a player character in the virtual space based on an operation input, and
the operation input of commanding to explode is to cause the player character to perform an action on the bomb object or the assembly object including the bomb object, based on an operation input.

5. The non-transitory computer-readable storage medium according to claim 1, wherein
the game processing further comprises:
when the explosion occurs, temporarily increasing the moment of inertia tensor of the target object before executing the physical calculation.

6. The non-transitory computer-readable storage medium according to claim 1, wherein
the target object is all objects that are at least partially included within a distance from the explosion occurrence position.

7. The non-transitory computer-readable storage medium according to claim 1, wherein
at least one of the first mass and the first speed is set to a value that decreases with an increase in a distance between the occurrence position and the impact position.

8. A game system comprising:
one or more processors; and
one or more memories storing instructions that, when executed, cause the game system to perform operations including:
executing movement control on at least one movable, dynamic object in a virtual space based on physical calculation;
generating at least one explosion with timing based on a game process; and
when the at least one explosion occurs, calculating a location and orientation of a target object present within a range from an occurrence position where each explosion occurs, based on physical calculation, assuming that a position on the target object closest to the occurrence position is an impact position, and if the target object is the dynamic object, a point having a first mass hits the target object at the impact position at a first speed in a direction from the occurrence position toward the impact position.

9. The game system according to claim 8, wherein
the dynamic object includes a bomb object, and
further,
at least one of the bomb objects is joined to at least one of the dynamic objects in the virtual space based on an operation input to obtain an assembly object, which is a dynamic object, and movement control is executed on the assembly object based on the physical calculation, and
the explosion is generated at a location of the bomb object with timing specified based on an operation input.

10. The game system according to claim 9, wherein
the bomb object explodes after a period of time has passed since performance of an operation input of commanding to explode.

11. The game system according to claim 10, wherein
further, a player character is controlled in the virtual space based on an operation input, and
the operation input of commanding to explode is to cause the player character to perform an action on the bomb object or the assembly object including the bomb object, based on an operation input.

12. The game system according to claim 8, wherein
further, when the explosion occurs, the moment of inertia tensor of the target object is temporarily increased before execution of the physical calculation.

13. The game system according to claim 8, wherein
the target object is all objects that are at least partially included within a distance from the explosion occurrence position.

14. The game system according to claim 8, wherein
at least one of the first mass and the first speed is set to a value that decreases with an increase in a distance between the occurrence position and the impact position.

15. A game apparatus comprising:
one or more processors; and
one or more memories storing instructions that, when executed, cause the game apparatus to perform operations including:
executing movement control on at least one movable, dynamic object in a virtual space based on physical calculation;
generating at least one explosion with timing based on a game process; and
when the at least one explosion occurs, calculating a location and orientation of a target object present within a range from an occurrence position where each explosion occurs, based on physical calculation, assuming that a position on the target object closest to the occurrence position is an impact position, and if the target object is the dynamic object, a point having a first mass hits the target object at the impact position at a first speed in a direction from the occurrence position toward the impact position.

16. The game apparatus according to claim 15, wherein
the dynamic object includes a bomb object, and
further,
at least one of the bomb objects is joined to at least one of the dynamic objects in the virtual space based on an operation input to obtain an assembly object, which is a dynamic object, and movement control is executed on the assembly object based on the physical calculation, and
the explosion is generated at a location of the bomb object with timing specified based on an operation input.

17. The game apparatus according to claim 16, wherein
the bomb object explodes after a period of time has passed since performance of an operation input of commanding to explode.

18. The game apparatus according to claim 17, wherein
further, a player character is controlled in the virtual space based on an operation input, and
the operation input of commanding to explode is to cause the player character to perform an action on the bomb object or the assembly object including the bomb object, based on an operation input.

19. The game apparatus according to claim 15, wherein
further, when the explosion occurs, the moment of inertia tensor of the target object is temporarily increased before execution of the physical calculation.

20. The game apparatus according to claim 15, wherein
the target object is all objects that are at least partially included within a distance from the explosion occurrence position.

21. The game apparatus according to claim 15, wherein
at least one of the first mass and the first speed is set to a value that decreases with an increase in a distance between the occurrence position and the impact position.

22. A game processing method for causing one or more processors of an information processing system to at least:
execute movement control on at least one movable, dynamic object in a virtual space based on physical calculation;
generate at least one explosion with timing based on a game process; and
when the at least one explosion occurs, calculate a location and orientation of a target object present within a range from an occurrence position where each explosion occurs, based on physical calculation, assuming that a position on the target object closest to the occurrence position is an impact position, and if the target object is the dynamic object, a point having a first mass hits the target object at the impact position at a first speed in a direction from the occurrence position toward the impact position.

23. The game processing method according to claim 22, wherein
the dynamic object includes a bomb object, and
further,
at least one of the bomb objects is joined to at least one of the dynamic objects in the virtual space based on an operation input to obtain an assembly object, which is a dynamic object, and movement control is executed on the assembly object based on the physical calculation, and
the explosion is generated at a location of the bomb object with timing specified based on an operation input.

24. The game processing method according to claim 23, wherein
the bomb object explodes after a period of time has passed since performance of an operation input of commanding to explode.

25. The game processing method according to claim 24, wherein
further, a player character is controlled in the virtual space based on an operation input, and
the operation input of commanding to explode is to cause the player character to perform an action on the bomb object or the assembly object including the bomb object, based on an operation input.

26. The game processing method according to claim 22, wherein
further, when the explosion occurs, the moment of inertia tensor of the target object is temporarily increased before execution of the physical calculation.

27. The game processing method according to claim 22, wherein
the target object is all objects that are at least partially included within a distance from the explosion occurrence position.

28. The game processing method according to claim 22, wherein
at least one of the first mass and the first speed is set to a value that decreases with an increase in a distance between the occurrence position and the impact position.
